(19) United States
(12) Patent Application Publication
(10) Pub. No.: US 2015/0085000 A1
(43) Pub. Date: Mar. 26, 2015

(54) METHOD FOR DRIVING DISPLAY DEVICE

(71) Applicants: Chia-chiang Lin, Shenzhen (CN); Hung-lung Hou, Shenzhen (CN)

(72) Inventors: Chia-chiang Lin, Shenzhen (CN); Hung-lung Hou, Shenzhen (CN)

(73) Assignee: Shenzhen China Star Opteelectronics Technology Co. Ltd., Shenzhen (CN)

(21) Appl. No.: 13/581,471

(22) PCT Filed: Jul. 9, 2012
(86) PCT No.: PCT/CN12/78373

§ 371 Date: Aug. 28, 2012

(30) Foreign Application Priority Data
Jul. 5, 2012 (CN) 201210231693.6

(51) Int. Cl. G09G 3/20

(52) U.S. Cl. CPC G09G 3/2003; G09G 2300/0465; G09G 2320/0233
USPC 345/694

(57) ABSTRACT

Disclosed is a method for driving a display device. The display device comprises scanning lines, data lines, pixels, a first source driving circuit, and a second source driving circuit. The scanning lines are sequentially located in a first region, an intermediate region, and a second region. Each data line is divided into two electrically disconnected lines. The method comprises: turning on one scanning line in the first region and one scanning line in the second region simultaneously; the first and second source driving circuits providing data for each pixel electrically connected to the turn-on scanning lines in the first and second regions; turning on one scanning line in the intermediate region; and providing data by the first or second source driving circuits according to a position in which each data line is divided into the two electrically disconnected lines.

### BACKGROUND OF THE INVENTION

1. Field of the Invention

The present invention generally relates to a display device technology field, and more particularly to a method for driving a display device.

2. Description of Prior Art

Please refer to FIG. 1. FIG. 1 shows a conventional display device 10. The display device comprises a plurality of scanning lines 100 (also called gate lines), a plurality of data lines 102 (also called source lines), and a plurality of pixels 104. Each of the pixels 104 is controlled to be turned on or turned off by one corresponding scanning line 100 and provided with data by one corresponding date line 102.

A conventional method for driving the display device 10 is to sequentially turn on the scanning lines 100 from the top to the bottom firstly. Then, the data lines 102 write data in the pixels 104 which are controlled by the turn-on scanning line 100. That is, one scanning line 100 is turned on per time in the conventional driving method. After the last scanning line 100 is turned on, all of the scanning lines 100 are sequentially turned on again from the first one to the last one.

To increase a displaying speed of the display device 10, a driving method of simultaneously turning on two scanning lines 100 is utilized currently. The data lines 102 write the data in the pixels 104 which are controlled by the two turn-on scanning lines 100. More particularly, the first scanning line 100 and the last scanning line 100 are turned on simultaneously, and the pixels 104 which are controlled by the first scanning line 100 and the pixels 104 which are controlled by the last scanning line 100 are provided with the data by two different source driving circuits (not shown). Then, the first scanning line 100 and the last scanning line 100 are turned off. Next, the second scanning line 100 and the second-last scanning line 100 are turned on simultaneously, and the pixels 104 which are controlled by the second scanning line 100 and the pixels which are controlled by the second-last scanning line 100 are provided with the data by the above-mentioned two different source driving circuits (not shown). The rest may be deduced by analogy. In summary, the scanning lines 100 in the above-mentioned driving method are driven from the top and bottom to the middle of the display device 10. Since the pixels 104 in an upper half region and the pixels 104 in a lower half region are provided with data by the two different source driving circuits (now shown) and output voltages of the two different source driving circuits have a voltage difference, a boundary line 110 is generated in a boundary position between the upper half region and the lower half region as shown in FIG. 2. More particularly, brightness in the upper half region is different from that in the lower half region, that is, mura phenomenon occurs, and thus display quality of the display device 10 is poor.

Therefore, there is a need for a solution to solve the above-mentioned problem that the brightness in the upper half region is different from that in the lower half region because the data are provided by the two different source driving circuits.

### SUMMARY OF THE INVENTION

An objective of the present invention is to provide a method for driving a display device for driving a display device which is capable of solving the problem that the brightness in the upper half region is different from that in the lower half region because the data are provided by the two different source driving circuits.

To solve the above-mentioned problem, the present invention provides a method for driving a display device. The display device comprises a plurality of scanning lines, a plurality of data lines crossed with the scanning lines, a plurality of pixels defined by the scanning lines and the data lines, a first source driving circuit, and a second source driving circuit. The scanning lines are sequentially located in a first region, an intermediate region, and a second region. Each of the data lines is divided into two electrically disconnected lines in a boundary position between the first region and the intermediate region, a boundary position between the intermediate region and the second region, or a position between any two scanning lines in the intermediate region. The method for driving the display device comprises: turning on one of the scanning lines in the first region along a first direction and one of the scanning lines in the second region along a second direction simultaneously, the first direction being opposite to the second direction; the first source driving circuit providing data for each of the pixels electrically connected to the turn-on scanning line in the first region through each of the data lines along the first direction, the second source driving circuit providing data for each of the pixels electrically connected to the turn-on scanning line in the second region through each of the data lines along the second direction; turning on one of the scanning lines in the intermediate region after scanning all of the scanning lines in the first region and the second region; and providing data by the first source driving circuit or the second source driving circuit according to the position in which each of the data lines is divided into the two electrically disconnected lines.

In the method for driving the display device of the present invention, at least one of the data lines is divided into the two electrically disconnected lines in the position different from the positions of the other of the data lines.

In the method for driving the display device of the present invention, two adjacent of the data lines are divided into the two electrically disconnected lines in different positions.

To solve the above-mentioned problem, the present invention further provides a method for driving a display device. The display device comprises a plurality of scanning lines, a plurality of data lines crossed with the scanning lines, a plurality of pixels defined by the scanning lines and the data lines, a first source driving circuit, and a second source driving circuit. The scanning lines are sequentially located in a first region, an intermediate region, and a second region. Each of the data lines is divided into two electrically disconnected lines. The method for driving the display device comprises: turning on one of the scanning lines in the first region along a first direction and one of the scanning lines in the second region along a second direction simultaneously; the first source driving circuit providing data for each of the pixels electrically connected to the turn-on scanning line in the first region through each of the data lines along the first direction, the second source driving circuit providing data for each of the pixels electrically connected to the turn-on scanning line in the second region through each of the data lines along the second direction; turning on one of the scanning lines in the intermediate region after scanning all of the scanning lines in the first region and the second region; and providing data by the first source driving circuit or the second source driving circuit according to the position in which each of the data lines is divided into the two electrically disconnected lines.

In the method for driving the display device of the present invention, each of the data lines is divided into the two electrically disconnected lines in a boundary position between the first region and the intermediate region, a boundary position between the intermediate region and the second region, or a position between any two scanning lines in the intermediate region.

In the method for driving the display device of the present invention, at least one of the data lines is divided into the two electrically disconnected lines in the position different from the positions of the other of the data lines.

In the method for driving the display device of the present invention, two adjacent of the data lines are divided into the two electrically disconnected lines in different positions.

In the method for driving the display device of the present invention, the first direction is opposite to the second direction.

To solve the above-mentioned problem, the present invention further provides a method for driving a display device. The display device comprises a plurality of scanning lines, a plurality of data lines crossed with the scanning lines, a plurality of pixels defined by the scanning lines and the data lines, a first source driving circuit, and a second source driving circuit. The scanning lines are sequentially located in a first region, an intermediate region, and a second region. Each of the data lines is divided into two electrically disconnected lines. The method for driving the display device comprises: turning on one of the scanning lines in the first region and one of the scanning lines in the second region simultaneously; the first source driving circuit providing data for each of the pixels electrically connected to the turn-on scanning line in the first region through one of the two electrically disconnected lines of each of the data lines, the second source driving circuit providing data for each of the pixels electrically connected to the turn-on scanning line in the second region through the other of the two electrically disconnected lines of each of the data lines; turning on one of the scanning lines in the intermediate region after scanning all of the scanning lines in the first region and the second region; and providing data by the first source driving circuit or the second source driving circuit according to a position in which each of the data lines is divided into the two electrically disconnected lines.

In the method for driving the display device of the present invention, each of the data lines is divided into the two electrically disconnected lines in a boundary position between the first region and the intermediate region, a boundary position between the intermediate region and the second region, or a position between any two scanning lines in the intermediate region.

In the method for driving the display device of the present invention, at least one of the data lines is divided into the two electrically disconnected lines in the position different from the positions of the other of the data lines.

In the method for driving the display device of the present invention, two adjacent of the data lines are divided into the two electrically disconnected lines in different positions.

Compared with the prior arts, the present invention is capable of solving the problem that the brightness in the upper half region is different from that in the lower half region because the data are provided by the two different source driving circuits.

For a better understanding of the aforementioned content of the present invention, preferable embodiments are illustrated in accordance with the attached figures for further explanation:

### BRIEF DESCRIPTION OF THE DRAWINGS

FIG. 1 shows a conventional display device;

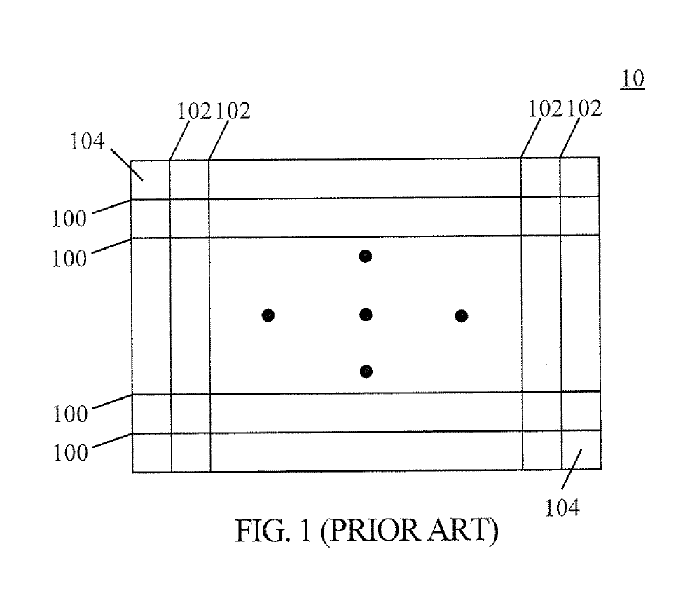

FIG. 2 shows that a boundary line is generated in a boundary position between the upper half region and the lower half region of the conventional display device;

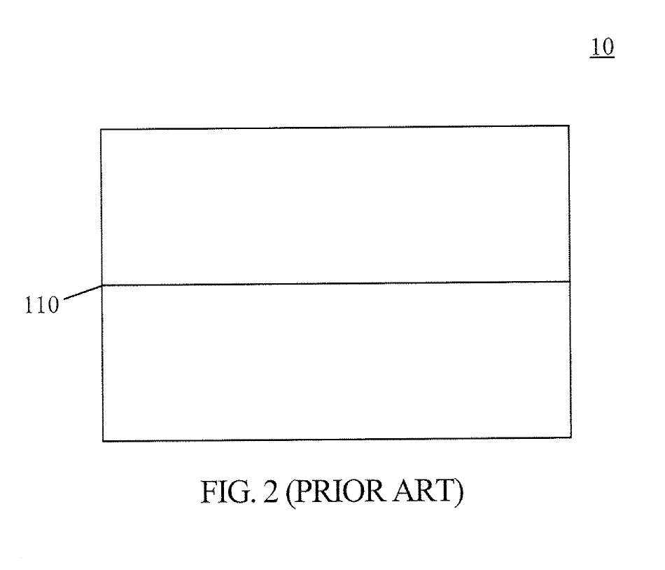

FIG. 3 shows a method for driving a display device according to a preferable embodiment of the present invention;

FIG. 4 shows a flow chart of a method for driving a display device according to a preferable embodiment of the present invention.

### DETAILED DESCRIPTION OF THE INVENTION

The following descriptions for the respective embodiments are specific embodiments capable of being implemented for illustrations of the present invention with referring to appended figures.

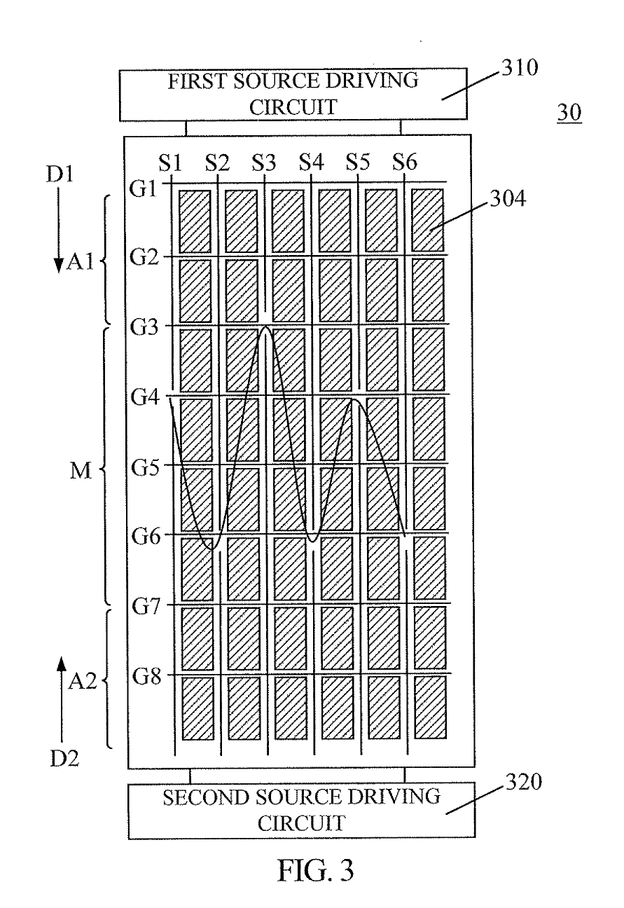

Please refer to FIG. 3. FIG. 3 shows a method for driving a display device according to a preferable embodiment of the present invention.

The display device 30 comprises a plurality of scanning lines G1-G8, a plurality of data lines S1-S6 which are crossed with the scanning lines G1-G8 insulatively, a plurality of pixels 304 which are defined by the scanning lines G1-G8 and the source lines S1-S6, a first source driving circuit 310, and a second source driving circuit 320. Each of the pixels 304 is controlled to be turned on or off by one of the scanning lines G1-G8 and provided with data by one of the data lines S1-S6.

The scanning lines G1-G8 are sequentially located in a first region A1, an intermediate region M, and a second region A2. In the present embodiment, the scanning lines G1-G2 are located in the first region A1, the scanning lines G3-G6 are located in the intermediate region M, and the scanning lines G7-G8 are located in the second region A2. The intermediate region M is a region where the boundary line occurs easily in the prior arts.

It is noted that in the present embodiment, two scanning lines are located in each of the first region A1 and the second region A2, while four scanning lines are located in the intermediate region M for the convenience of description. In a practical display device, a number of the scanning lines in the first region A1 and the second region A2 are greatly larger than a number of the scanning lines in the intermediate region M.

Each of the data lines S1-S6 is divided into two electrically disconnected lines. Preferredly, each of the data lines S1-S6 is divided into the two electrically disconnected lines in a boundary position between the first region A1 and the intermediate region M, a boundary position between the intermediate region M and the second region A2, or a position between any two scanning lines in the intermediate region M. Furthermore, at least one of the data lines S1-S6 is divided into the two electrically disconnected lines in a position different from positions of the other of the data lines S1-S6.

In the present embodiment, two adjacent of the data lines are divided into the two electrically disconnected lines in different positions. The data line S1 is divided into the two electrically disconnected lines in a position between the scanning line G3 and the scanning line G4 (a position between the two scanning lines in the intermediate region M). The data line S2 is divided into the two electrically disconnected lines in a position between the scanning line G5 and the scanning line G6 (a position between the two scanning lines in the intermediate region M). The data line S3 is divided into the two electrically disconnected lines in a position between the scanning line G2 and the scanning line G3 (a boundary position between the first region A1 and the intermediate region M). The data line S4 is divided into the two electrically disconnected lines in a position between the scanning line G5 and the scanning line G6 (a position between the two scanning lines in the intermediate region M). The data line S5 is divided into the two electrically disconnected lines in a position between the scanning line G3 and the scanning line G4 (a position between the two scanning lines in the intermediate region M). The data line S6 is divided into the two electrically disconnected lines in a position between the scanning line G5 and the scanning line G6 (a position between the two scanning lines in the intermediate region M).

Firstly, in a first period, the scanning line G1 in the first region A1 along a first direction D1 (i.e. the first scanning line along the first direction D1) and the scanning line G8 in the second region A2 along a second direction D2 opposite to the first direction D1 (i.e. the first scanning line along the second direction D2) are turned on simultaneously. The first source driving circuit 310 provides data for the pixels 304 electrically connected to the scanning line G1 through the upper lines of the data lines S1-S6 along the first direction D1 The second source driving circuit 320 provides data for the pixels 304 electrically connected to the scanning line G8 through the lower lines of the data lines S1-S6 along the second direction D2. Then, the scanning line G1 in the first region A1 and the scanning line G8 in the second region A2 are turned off.

In a second period, the scanning line G2 in the first region A1 and the scanning line G7 in the second region A2 are turned on simultaneously. The first source driving circuit 310 provides data for the pixels 304 electrically connected to the scanning line G2 through the upper lines of the data lines S1-S6. The second source driving circuit 320 provides data for the pixels 304 electrically connected to the scanning line G7 through the lower lines of the data lines S1-S6. Then, the scanning line G2 in the first region A1 and the scanning line G7 in the second region A2 are turned off.

In a third period, only one scanning line, i.e. the scanning line G3, is turned on per time when scanning the intermediate region M. Since the data line S3 is divided into the two electrically disconnected lines, the second source driving circuit 320 provides data for the pixel 304 electrically connected to the scanning line G3 through the lower line of the data line S3 and the first source driving circuit 310 provides data for the pixels 304 electrically connected to the scanning line G3 through the upper lines of the data lines S1, S2, S4, S5, S6. Then, the scanning line G3 in the intermediate region M is turned off.

In a fourth period, only the scanning line G4 in the intermediate region M is turned on. The first source driving circuit 310 provides data for the pixels 304 electrically connected to the scanning line G4 through the upper lines of the data lines S2, S4, S6. The second source driving circuit 320 provides data for the pixels 304 electrically connected to the scanning line G4 through the lower lines of the data lines S1, S3, S5. Then, the scanning line G4 in the intermediate region M is turned off.

In a fifth period, only the scanning line G5 in the intermediate region M is turned on. The first source driving circuit 310 provides data for the pixels 304 electrically connected to the scanning line G5 through the upper lines of the data lines S2, S4, S6. The second source driving circuit 320 provides data for the pixels 304 electrically connected to the scanning line G5 through the lower lines of the data lines S1, S3, S5. Then, the scanning line G5 in the intermediate region M is turned off.

In a sixth period, only the scanning line G6 in the intermediate region M is turned on. Since the data lines S1-S6 are divided into the two electrically disconnected lines in the positions above the scanning line G6, the first source driving circuit 310 fails to provide data for the pixels 304 electrically connected to the scanning line G6 through the upper lines of the data lines S1-S6. Accordingly, the second source driving circuit 320 provides data for the pixels 304 electrically connected to the scanning line G6 through the lower lines of the data lines S1-S6. Then, the scanning line G6 in the intermediate region M is turned off.

It can be appreciated from the embodiment in FIG. 3 that when scanning the first region A1 and the second region A2, two scanning lines including one scanning line in the first region A1 and one scanning line in the second region A2 are turned on simultaneously in both the method for driving the display device of the present invention and the prior arts. The pixels 304 in the first region A1 are provided with data by the first source driving circuit 310, while the pixels 304 in the second region A2 are provided with data by the second source driving circuit 320. When scanning the intermediate region M, only one scanning line is turned on per time. When scanning the intermediate region M, each of the data line S1-S6 is provided with data by the first source driving circuit 310 or the second source driving circuit 320 according to the position in which each of the data lines S1-S6 is divided into the two electrically disconnected lines.

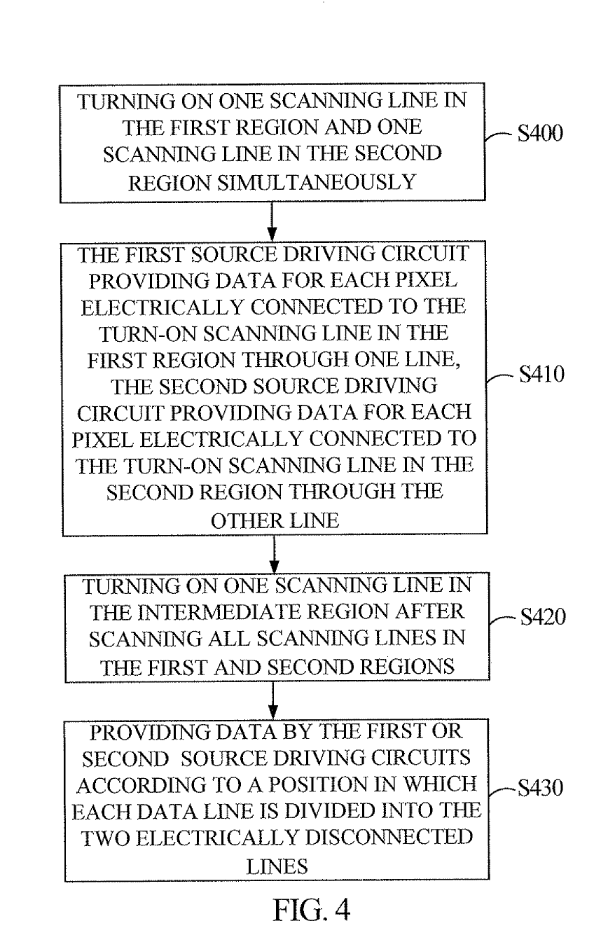

It is noted that the first region A1 and the second region A2 are scanned from the two opposite directions D1, D2 in the embodiment of FIG. 3. In another embodiment, scanning the first region A1 and the second region A2 by selecting any one of the scanning lines in the first region A1 and any one of the scanning line in the second region A2 to be turned on simultaneously (as described in a flow chart of FIG. 4) may be substituted for scanning the first region A1 and the second region A2 according to the two opposite directions D1, D2.

Please refer to FIG. 4. FIG. 4 shows a flow chart of a method for driving a display device according to a preferable embodiment of the present invention. The display device comprises a plurality of scanning lines, a plurality of data lines which are crossed with the scanning lines, a plurality of pixels which are defined by the scanning lines and the data lines, a first source driving circuit, and a second source driving circuit. The scanning lines are sequentially located in a first region, an intermediate region, and a second region. Each of the data lines is divided into two electrically disconnected lines.

In one embodiment, each of the data lines is divided into the two electrically disconnected lines in a boundary position between the first region and the intermediate region, a boundary position between the intermediate region and the second region, or a position between any two scanning lines in the intermediate region.

Preferably, at least one of the data lines is divided into the two electrically disconnected lines in a position different from positions of the other of the data lines. More preferredly, two adjacent of the data lines are divided into the two electrically disconnected lines in different positions.

In step S400, one scanning line in the first region and one scanning line in the second region are turned on simultaneously.

In step S410, the first source driving circuit provides data for each of the pixels electrically connected to the turn-on scanning line in the first region through one of the two lines of each of the data lines. The second source driving circuit provides data for each of the pixels electrically connected to the turn-on scanning line through the other one of the lines of each of the data lines.

In step S420, after scanning all of the scanning lines in the first region and the second region, one of the scanning lines in the intermediate region is turned on.

In step S430, data are provided by the first source driving circuit or the second source driving circuit according to a position in which each of the data lines is divided into the two electrically disconnected lines.

In the method for driving the display device of the present invention, two scanning lines which are respectively located in the upper half region and the lower half region (i.e. the first region and the second region) are turned on simultaneously per time, while only one scanning line in the intermediate region is turned on per time. Since the number of the scanning lines in the upper half region and the lower half region is greatly large than the number of the scanning lines in the intermediate region, two scanning lines are driven to be turned on simultaneously most of the time. Accordingly, the advantage of increasing the displaying speed of the display device in the prior arts may be retained. When scanning the intermediate region, only one scanning line is turned on per time. Accordingly, a brightness difference in the intermediate region may be decreased, so that human eyes cannot perceive the brightness difference. As a result, the problem that the boundary line in the prior arts can be improved, that is, the mura phenomenon can be avoided.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A method for driving a display device, the display device comprising a plurality of scanning lines, a plurality of data lines crossed with the scanning lines, a plurality of pixels defined by the scanning lines and the data lines, a first source driving circuit, and a second source driving circuit, the scanning lines sequentially located in a first region, an intermediate region, and a second region, each of the data lines divided into two electrically disconnected lines in a boundary position between the first region and the intermediate region, a boundary position between the intermediate region and the second region, or a position between any two scanning lines in the intermediate region, the method for driving the display device comprising:
turning on one of the scanning lines in the first region along a first direction and one of the scanning lines in the second region along a second direction simultaneously, the first direction being opposite to the second direction;
the first source driving circuit providing data for each of the pixels electrically connected to the turn-on scanning line in the first region through each of the data lines along the first direction, the second source driving circuit providing data for each of the pixels electrically connected to the turn-on scanning line in the second region through each of the data lines along the second direction;
turning on one of the scanning lines in the intermediate region after scanning all of the scanning lines in the first region and the second region; and
providing data by the first source driving circuit or the second source driving circuit according to the position in which each of the data lines is divided into the two electrically disconnected lines.

2. The method for driving the display device of claim 1, wherein at least one of the data lines is divided into the two electrically disconnected lines in the position different from the positions of the other of the data lines.

3. The method for driving the display device of claim 1, wherein two adjacent of the data lines are divided into the two electrically disconnected lines in different positions.

4. A method for driving a display device, the display device comprising a plurality of scanning lines, a plurality of data lines crossed with the scanning lines, a plurality of pixels defined by the scanning lines and the data lines, a first source driving circuit, and a second source driving circuit, the scanning lines sequentially located in a first region, an intermediate region, and a second region, each of the data lines divided into two electrically disconnected lines, the method for driving the display device comprising:
turning on one of the scanning lines in the first region along a first direction and one of the scanning lines in the second region along a second direction simultaneously;
the first source driving circuit providing data for each of the pixels electrically connected to the turn-on scanning line in the first region through each of the data lines along the first direction, the second source driving circuit providing data for each of the pixels electrically connected to the turn-on scanning line in the second region through each of the data lines along the second direction;
turning on one of the scanning lines in the intermediate region after scanning all of the scanning lines in the first region and the second region; and
providing data by the first source driving circuit or the second source driving circuit according to the position in which each of the data lines is divided into the two electrically disconnected lines.

5. The method for driving the display device of claim 4, wherein each of the data lines is divided into the two electrically disconnected lines in a boundary position between the first region and the intermediate region, a boundary position between the intermediate region and the second region, or a position between any two scanning lines in the intermediate region.

6. The method for driving the display device of claim 4, wherein at least one of the data lines is divided into the two electrically disconnected lines in the position different from the positions of the other of the data lines.

7. The method for driving the display device of claim 4, wherein two adjacent of the data lines are divided into the two electrically disconnected lines in different positions.

8. The method for driving the display device of claim 4, wherein the first direction is opposite to the second direction.

9. A method for driving a display device, the display device comprising a plurality of scanning lines, a plurality of data lines crossed with the scanning lines, a plurality of pixels defined by the scanning lines and the data lines, a first source driving circuit, and a second source driving circuit, the scanning lines sequentially located in a first region, an intermediate region, and a second region, each of the data lines divided into two electrically disconnected lines, the method for driving the display device comprising:
turning on one of the scanning lines in the first region and one of the scanning lines in the second region simultaneously;
the first source driving circuit providing data for each of the pixels electrically connected to the turn-on scanning line in the first region through one of the two electrically disconnected lines of each of the data lines, the second source driving circuit providing data for each of the pixels electrically connected to the turn-on scanning line in the second region through the other of the two electrically disconnected lines of each of the data lines;
turning on one of the scanning lines in the intermediate region after scanning all of the scanning lines in the first region and the second region; and
providing data by the first source driving circuit or the second source driving circuit according to a position in which each of the data lines is divided into the two electrically disconnected lines.

10. The method for driving the display device of claim 9, wherein each of the data lines is divided into the two electrically disconnected lines in a boundary position between the first region and the intermediate region, a boundary position between the intermediate region and the second region, or a position between any two scanning lines in the intermediate region.

11. The method for driving the display device of claim 9, wherein at least one of the data lines is divided into the two electrically disconnected lines in the position different from the positions of the other of the data lines.

12. The method for driving the display device of claim 9, wherein two adjacent of the data lines are divided into the two electrically disconnected lines in different positions.
